(19) United States
(12) Patent Application Publication
(10) Pub. No.: US 2004/0230146 A1
(43) Pub. Date: Nov. 18, 2004

(54) Activated massage pad structure

(76) Inventor: Freddie Chang, Arcadia, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 10/632,336

(22) Filed: Aug. 1, 2003

(30) Foreign Application Priority Data
May 15, 2003 (TW) 92208911

(51) Int. Cl. A61H 11/00; A61H 7/00

(52) U.S. Cl. 601/134; 601/136

(57) ABSTRACT

The present invention discloses an activated massage pad structure that can be applied to massage pads such as cushions, shoes, cooling mats, or pillows to give a rubbing and messaging functions with movable directions, comprising a flexible pad; a message protrusion movably disposed on the surface of the flexible pad; and a floating chamber movably disposed in the pad, such that the message protrusion has the function of switching directions by the arrangement and response of the floating chamber.

### RELATED PATENT APPLICATION INFORMATION

This application claims foreign priority benefits under 35 U.S.C. 119(a)-(d) from Taiwan patent application Ser. No. 92208911, filed on May 15, 2003 in the Taiwanese Intellectual Property Office.

### Field of the Invention

The present invention relates to an activated massage pad structure, more particularly a massage pad having an activated massage at different pressing directions. Its application covers the mats, shoes, cooling mats, and pillows that can message human acupunctural points by rolling and rubbing.

### Background of the Invention

An acupunctural message targets the acupunctural points of the whole body to provide physical and mechanical treatment for promoting blood circulation. Such acupunctural message stems from ancient Chinese clinical tests and, based on Chinese medical theories, became a foundation of the basic theoretical system. Once the acupunctural points are opened, blood circulation can be activated to produce vitality, energy, and coordinated blood circulation of the whole body and the related internal organs for healthy activity, and further invigorating cells, which has a positive effect on natural therapy. The massage also has similar effects associated with the internal organs as to the reflective areas of the nervous system. If those reflective areas are stimulated by the massage, then the central nervous system will send a signal to the central nerves to start the related mechanism or activate secretions to harmonize the normal operation of internal organs, which has a proven medical effect on preventing diseases. Therefore, health equipment having a pad with related massage functions can be designed into shoes or cushions, or many other areas.

Please refer to FIG. 1 for the prior-art design disclosed in R.O.C. Patent Publication No. 265537, comprising a cylindrical body 20 disposed at the bottom of a sole, the cylindrical body 20 having a massage pillar 10 rotationally coupled to the cylindrical body 20 for vertically adjusting its height in order to adjust the magnitude and evenness of the pressure in contact with the acupunctural points on the sole of the foot.

Please refer to FIG. 2 for the structure of the prior-art sole-massaging shoes disclosed in R.O.C. Patent Publication No. 271550, comprising an insole 30 with a wooden surface made according to the geometric curvature of the sole of a human body; a meshed sole 40 disposed on the surface of the wooden insole 30; a plurality of spherical protrusions disposed on the wooden insole 30 and passing through the meshed sole 40 to provide a massage to the wearer's sole during walking.

Please refer to FIG. 3 for the massaging sole disclosed in R.O.C. Patent Publication No. 307791, comprising a sole 60, a plurality of holes on the surface for letting the massage protrusions 50 pass through, and a filling stuffed inside massage protrusion 50 for support, where the filling could be made of a magnetic or far infrared material, wherein the far infrared material is built-in and the action surface is isolated by the massage protrusions. As a result, this blocks the far infrared and theoretically provides a reduced effect.

Please refer to FIG. 4 for the massaging sole disclosed in R.O.C. Patent Publication No. 510219, comprising a thin plate with a plurality of holes; a fixture disposed under the thin plate; and a fixed massage member passing through the holes.

As shown in the related-massaging sole design of the prior art, the massage members have protrusions and pads designed in a fixed direction. Therefore, the sole is pressed and acted upon by a single position to create a slight massage operation when wearing such shoes. However, the acupunctural points are distributed all over the foot instead of being concentrated at a point; the acupunctural points cover a small area close in size to the area of a thumb, and are preferably able to accept a massage over all areas. Further, the prior-art massage operation can only massage in a vertical direction, and is unable to rub the acupunctural points.

Thus, the present invention provides an activated massage pad, mainly forming a plurality of floating chambers within the lining of the pad. Since a massage protrusion is movably disposed in the floating chamber, the hemispherical top of the massage protrusion produces a movement with a broadened massage function of pressing and rubbing the acupunctural points.

### SUMMARY OF THE PREFERRED EMBODIMENTS

The primary objective of the present invention is to provide a flexible pad having a plurality of massage protrusions in its lining, a hemispherical top of the massage protrusion creating a stimulating function for the user according to the change of position of the user's body to attain the massage function by pressing and rubbing, and also extending the rubbing and massaging areas of the acupunctural points.

### BRIEF DESCRIPTION OF THE DRAWINGS

Other features and advantages of the present invention will become apparent in the following detailed description of the preferred embodiments with reference to the accompanying drawings, in which:

FIGS. 1 to 4 are illustrative diagrams of the structures according to the prior art.

FIG. 5 is a perspective diagram of the construction of a massage protrusion with a pad according to the present invention.

FIG. 6 is a perspective diagram of the massage protrusion according to the present invention.

FIG. 7 is an illustrative diagram of the movement of the massage protrusion according to the present invention.

FIG. 8 is an illustrative diagram of the assembled massage protrusion according to the present invention.

FIG. 9 is an illustrative diagram of the rotation produced by the massage protrusion according to the present invention.

FIG. 10 is an illustrative diagram of an additional embodiment of the present invention.

FIG. 11 is a perspective diagram of a preferred embodiment of use of the present invention.

FIG. 12 is a perspective diagram of another preferred embodiment of use of the present invention.

FIG. 13 is an illustrative diagram of the massage protrusion of a preferred embodiment of the present invention.

FIG. 14 is an illustrative diagram of an opening of the massage protrusion of the present invention.

FIG. 15 is an illustrative diagram of holes disposed on the massage protrusion of the present invention.

FIG. 16 is an illustrative diagram of magnetic members assembled into the massage protrusion of the present invention.

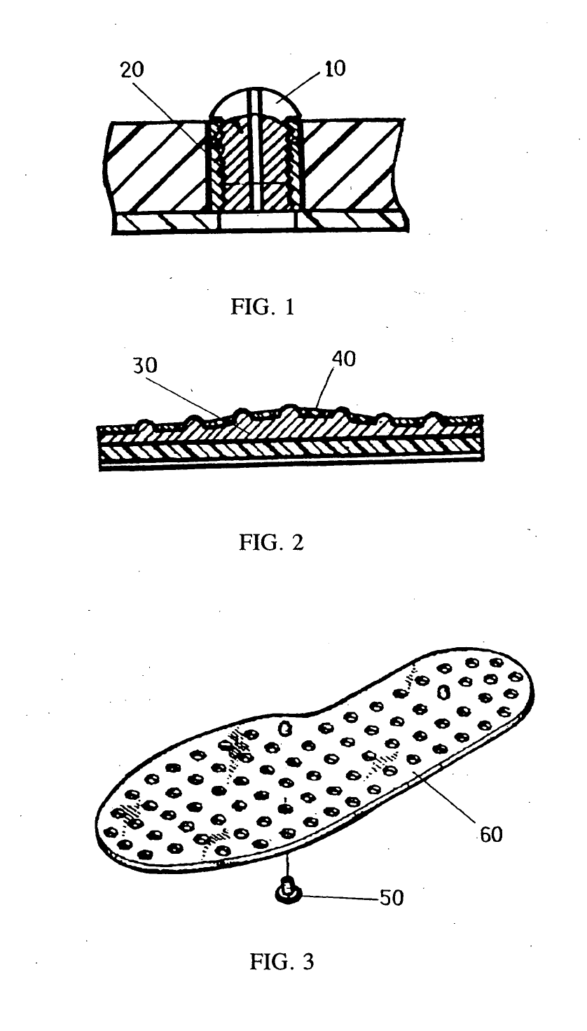

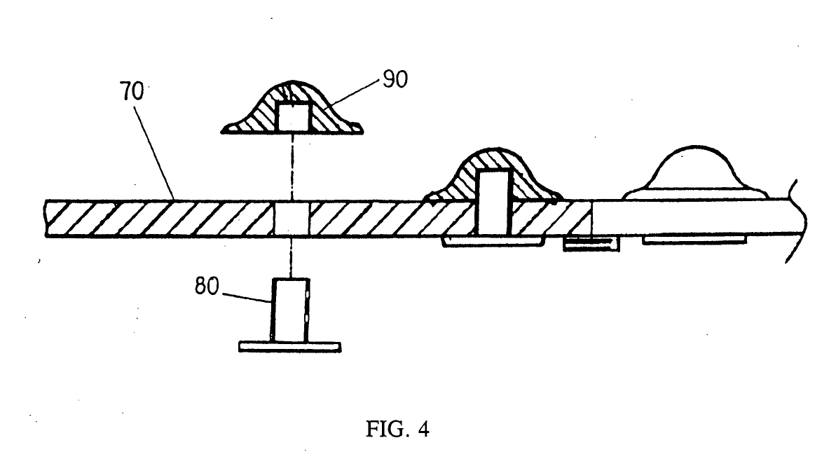

### DETAILED DESCRIPTION OF THE INVENTION

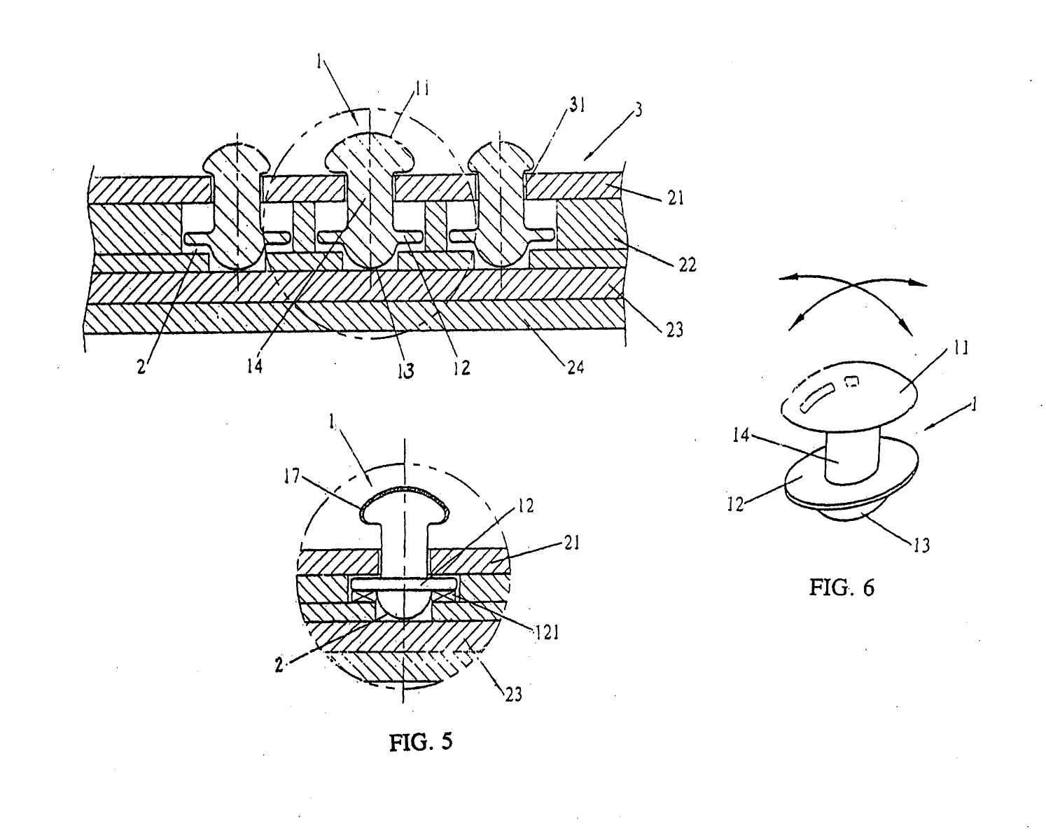

Please refer to FIG. 5 for a detailed illustration of the present invention. A pad 3 is a flexible member, basically comprising a mat 21 with through holes 31, a middle layer 22; and a pad plate 23, and a slip-resistant layer 24 can be set at the utmost bottom, wherein the middle layer 22 has a floating chamber 2, and a massage protrusion is movably disposed on such floating chamber 2. A massage protrusion 1 has a hemispherical top 11, a hemispherical bottom 13 connected to the bottom of the hemispherical top 11, and an arresting ring 12 extended from the position proximate the hemispherical bottom 13. The arresting ring 12 floats in the floating chamber 2 and is also limited by the floating chamber 2 to prevent it from coming out. The mat 21 is a flexible member, and the through hole 31 allows a connecting pillar 14 to pass through, which provides general support to the massage protrusion 1. When the massage protrusion 1 is stepped on by the user's foot, the force is passed down to the massage protrusion 1, the hemispherical bottom 13 and then onto the corresponding surface of the pad plate 23. The pad plate can be made of a firm material, so that the result of the pressing force is a reaction to the user's corresponding muscle through the hemispherical top 11.

Further, an elastic tension member 121 can be installed under the arresting ring 12 of the massage protrusion 1, and the lower surface of the elastic tension member 121 acts on the related corner position of the floating chamber 2. Due to the resiliency of the elastic member 121, the massage protrusion 1 will be in a floating state when it is not pressed. The massage protrusion 1 will be affected by the resiliency of the elastic member 121 after the massage protrusion 1 is pressed, and then the massage protrusion 1 will descend to a point supported by the pad plate 23. Such arrangement also provides a massage in an opposite direction. Furthermore, the massage protrusion 1 is normally kept in the floating state, and is thus in contact with the skin surface of the related acupunctural points of the user for confirming the positions of the massage. The central nervous system also sends a signal to psychologically prepare the user for the massage. For those who are afraid of pain, such arrangement eases the anxiety of the user by psychologically preparing and guiding the user in advance.

Further, a ceramic material can be used to make the massage protrusion 1. In the manufacturing process, a far infrared converting material such as feldspar, magnesium oxide, zirconium oxide can be added so that sintering forms an integral body, or other materials can be used so that the surface of the upper hemispherical body 11 of the massage protrusion 1 at least forms a far infrared converting layer 17. The converting layer 17 emits far infrared waves to act on the circulating blood, and produces resonance to the electrons in the blood cells and activates blood circulation.

Please refer to FIG. 6, where it is shown that hemispherical top 11 may freely move in all directions. The hemispherical bottom 13 comprises a hemisphere, the arresting ring 12, and a connecting pillar 14, which is limited by the floating chambers 2 for erecting the massage protrusion 1.

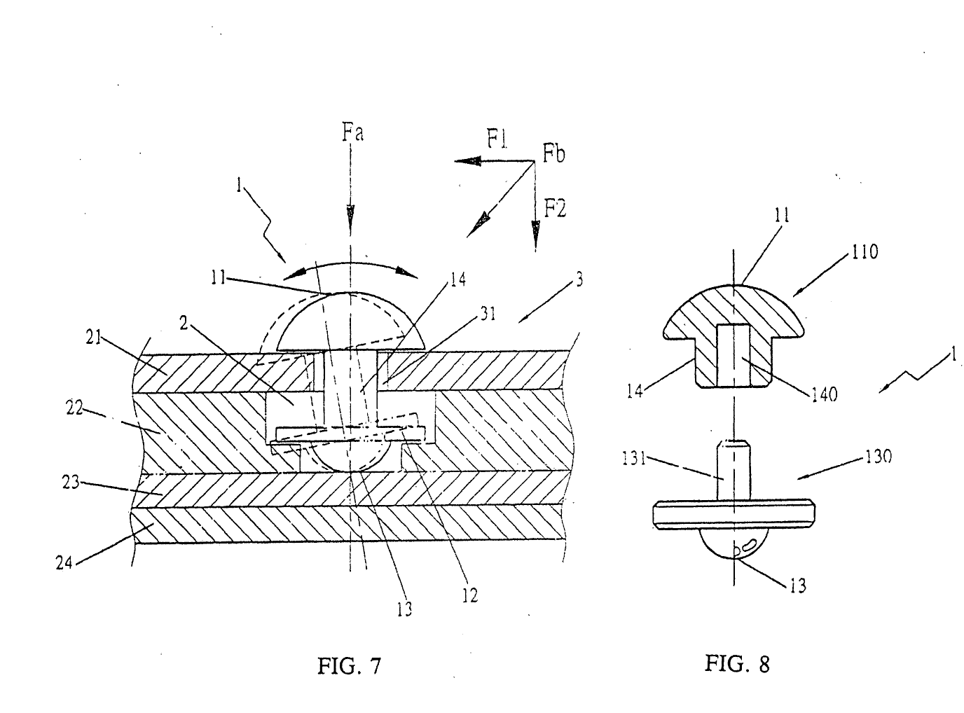

Please refer to FIG. 7 for the movement of the hemispherical top 11. The lower section of the massage protrusion 1 is installed into the base and limited by the floating chambers 2 of the middle layer 22, and is passed through the mat 21 with the connecting pillar 14. Thus, before or during the massage, the massage protrusion 1 is vertical to the pad 3, and the vertical acting force is Fₐ. If the massage protrusion is kept in a vertical position, and the acting force F_{b} is in a slant direction, then it will produce a vertical acting force F₂ and a horizontal acting force F₁, making the hemispherical top 11 move in the same direction as the horizontal acting force F₁. The fulcrum of the movement is the contact point of the related pad plate 3 from the hemispherical bottom.13, which forms a pressing force by rolling. In the meantime, the arresting ring 12 of the massage protrusion 1 will be aslant, and will act on the corresponding pressing surfaces of the mat 21 and the middle layer 22.

The middle layer 22 and mat 21 are basically made of elastic materials, therefore, they will deform according to the displacement of the arresting ring 12, and the through hole 31 will produce an elastic deformation according to the swinging movement of the connecting pillar 14. After the acting force F_{b} is eliminated, the elastic restoration of the mat 21 and the middle layer 22 returns the massage protrusion 1 into the vertical position. Therefore, the swinging movement (if applied to the sole of the shoes), which is the acting force on the sole, will have different directions due to the varying force produced during the walking. Different aslant acting forces will be produced according to the different directions of the walk, and thus the aslant acting force will press and roll all over the area of the acupunctural points, or even attaining a rubbing effect. Such rubbing is produced by the related pressing and rolling of the hemispherical top 11. This invention can be applied to shoes, cushions, or even the back of a chair, cooling mat or pillows, and anywhere that a user needs a massage pad within the range of a body movement.

Further, the size of the hemispherical top 11 of the massage protrusion 1 can be varied as shown in the embodiment in FIG. 8. The massage protrusion 1 is divided into an upper body section 110 and a root section 130, and the root section 130 also has the hemispherical bottom 13 with a connecting latch 131 at the top. The connecting latch 131 provides the connecting pillar 14 of the hemispherical top 11 to pass through the connecting hole 140 in the lining. Such a design standardizes the root section 130 and the floating chamber 2 of the pad 3 into a manufacturable state for facilitating production. The hemispherical top 11 may have different sizes according to the position and size of the acupunctural points by the connecting various versions of the upper body section 110 to the root section 130.

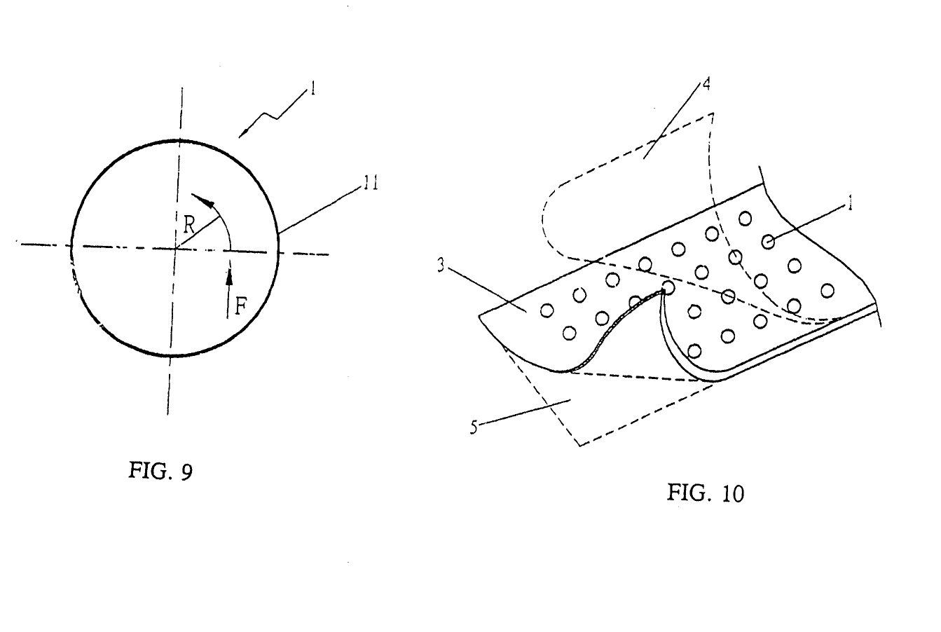

Please refer to FIG. 9. Since the massage protrusion 1 is cylindrical, it will rotate along its center and provide a rubbing effect by reacting to external forces from different angles, depending on whether the user is sitting, lying, or stepping on it.

If the acting force acts on a position offset from the center of the hemispherical top 11, such as the position on a radius R, then a component force will be formed to rotate the hemispherical top 11 of the massage protrusion, and such rotation will have positive effects on enhancing the rubbing operation.

Please refer to FIG. 10 for the present invention. After the massage protrusion 1 is assembled onto the surface of the pad 3, a layer 4 is used to isolate and prevent water vapor and dust, or even provide a disinfecting effect. The implementation of such isolating layer requires an appropriately reserved space for the range of movement of the massage protrusion 1 in order to provide the space for the movement of the massage protrusion 1.

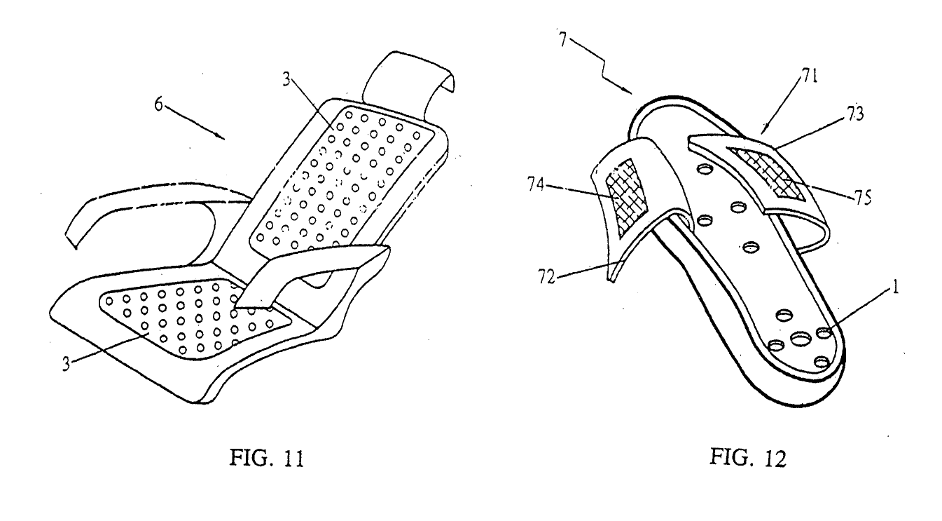

Further, an attachment layer 5 of a fastener can be installed under the pad 3. The attachment layer 5 can be applied to the cushion or the surface of the back of a chair 6 as shown in FIG. 11 to attach the pad 3 onto the surface of the cushion or the back of the chair 6. Such attachment layer 5 can be attached by means of an adhesive layer or a gluing layer.

Please refer to FIG. 12 for an embodiment of the present invention being applied to shoes 7. If this invention is applied to the upper section of the sole, then the massage protrusions can be set on the surface corresponding to the human acupunctural points, and the size of massage protrusion 1 can be varied according to the area of the acupunctural point. A vamp 71 is placed in front of the shoe body 7, and the vamp 71 includes an inner vamp 73 and an outer vamp 72 mutually connected by a pair of fasteners 74, 75 to adjust the size of the vamp to wrap around the sole of the foot.

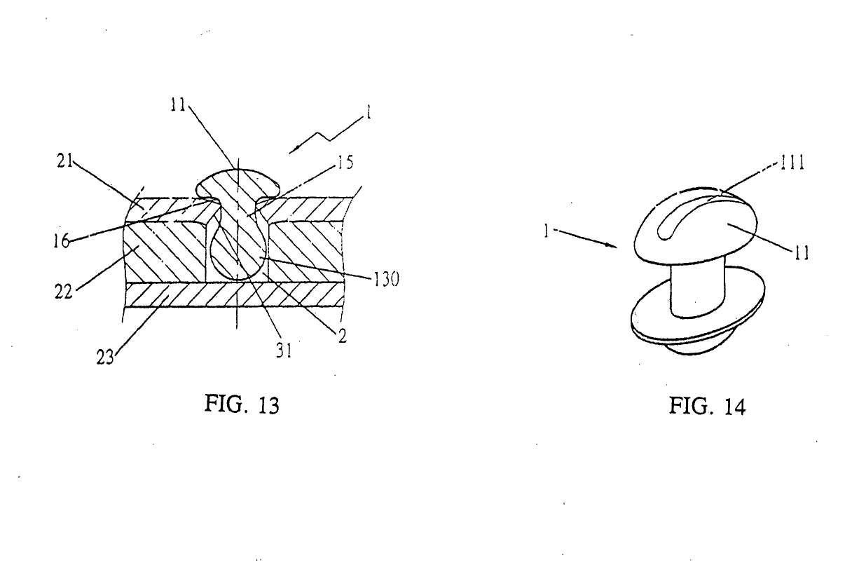

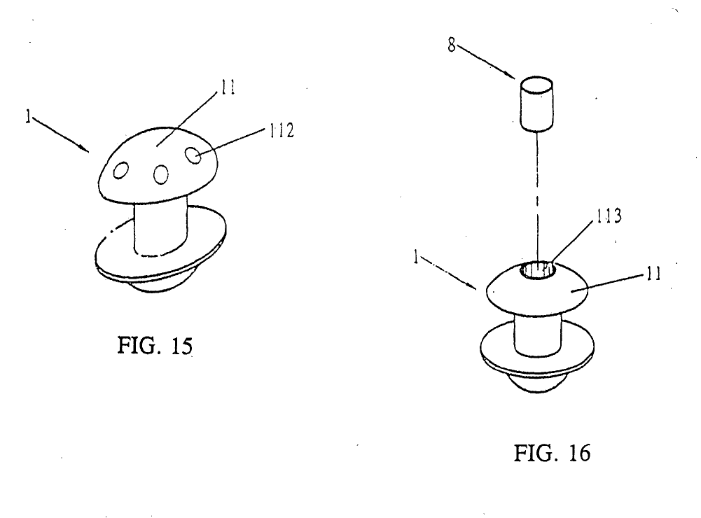

Please refer to FIG. 13 for another embodiment of the bottom section of the massage protrusion according to the present invention. The root section 130 can be designed in the shape of a water drop to provide reacting forces on the bottom of the floating chamber 2 and limiting its range of activities, and is connected to the hemispherical top 11 of a neck section 15. A curved corner 16 is disposed at the connection of the corners to spread out the stress on the bottom of the water-drop shaped root section 130 and make it easier to pass through the through hole 31, and be fixed into the floating chamber 2.

By the curved surface of the curved corner 16, the root section 130 can be secured to the through hole 31 such that the area of the mat 21 proximate to the surrounding of the through hole 31 will deform and subside. By the stress of such deformation, the circular surrounding will press upward onto the corresponding surface of the curved corner 16 or the root section 15 to form a sealed state and naturally generates a dirt protective effect.

Please refer to FIG. 14 for the upper surface of the hemispherical top 11 of the massage protrusion 1, comprising an opening groove 111, and a hole 112 disposed on the upper surface of the hemispherical top 11 of the massage protrusion 1. Use of the opening groove 111 and the hole 112 provides better friction to the skin of the user when the massage is taken place. The embodiment as shown in FIG. 9 assures a larger amount of friction so that the massage protrusion can be pushed and rotated to attain the rubbing and messaging operation.

Please refer to FIG. 16. An embedding hole 113 is disposed on the upper surface of the hemispherical top 11 of the massage protrusion 1, and the embedding hole 113 can provide a magnetic member 8 for its physical magnetic treatment effect and will rearrange the electronic structure of the cells and activate the blood circulation with an supplementary medical treatment effect to a certain extent.

What is claimed is:

1. A massage protrusion for use in a massage pad structure having a chamber accessible through an opening on a top surface of the massage pad structure, the massage protrusion comprising:
a hemispherical top movably disposed on the top surface; and,
a root section coupled to the hemispherical top through the opening and movably disposed in and limited by the chamber.

2. The massage protrusion of claim 1, wherein each massage protrusion further comprises a connecting pillar that extends downward from the hemispherical top and couples to the root section.

3. The massage protrusion of claim 1, wherein the root section comprises a hemispherical bottom coupled to the connecting pillar, the hemispherical bottom having a diameter greater than the diameter of the opening.

4. The massage protrusion of claim 1, wherein the root section comprises a hemispherical bottom coupled to the connecting pillar, the hemispherical bottom having an arresting ring disposed at a bottom portion of the connecting pillar.

5. The massage protrusion of claim 4, wherein the arresting ring having an outside diameter greater than the diameter of the opening.

6. The massage protrusion of claim 1, further comprising an elastic tension member displaced in the chamber and supporting the root section.

7. The massage protrusion of claim 1, wherein the root section has a spherical shape coupled to the hemispherical top through a neck section.

8. The massage protrusion of claim 1, wherein the root section has a water-drop shape with a tapered portion coupled to the hemispherical top through a neck section.

9. The massage protrusion of claim 1, wherein the hemispherical top has a magnetic member embedded therein.

10. The massage protrusion of claim 1, wherein the hemispherical top is made of a ceramic material.

11. The massage protrusion of claim 1, wherein the hemispherical top is coated with a far infrared converting material.

12. The massage protrusion of claim 1, wherein the hemispherical top of the massage protrusion includes a groove.

13. The massage protrusion of claim 1, wherein the hemispherical top of the massage protrusion includes an opening on a top surface.

14. A massage pad structure comprising:
a mat having a plurality of through holes;
a pad plate;
a middle layer sandwiched between the mat and the pad plate and having a plurality of chambers, each of the plurality of chambers accessible through a through hole of the plurality of through holes;
a plurality of massage protrusions, each massage protrusion having:
a hemispherical top movably disposed on the mat;
a root section coupled to the hemispherical top through the through hole and movably disposed in and limited by a chamber of the plurality of chambers.

15. The massage pad structure of claim 14, wherein each massage protrusion further comprises a connecting pillar that extends downward from the hemispherical top, passes through the through hole and couples to the root section.

16. The massage pad structure of claim 14, wherein the root section comprises a hemispherical bottom coupled to the connecting pillar, the hemispherical bottom having a diameter greater than the diameter of the through hole.

17. The massage pad structure of claim 14, wherein the root section comprises a hemispherical bottom coupled to the connecting pillar, the hemispherical bottom having an arresting ring disposed at a bottom portion of the connecting pillar.

18. The massage pad structure of claim 17, wherein the arresting ring having an outside diameter greater than the diameter of the through hole.

19. The massage pad structure of claim 14, further comprising an elastic tension member displaced in the chamber and supporting the root section.

20. The massage pad structure of claim 14, wherein the root section has a shape selected from the collection of a water-drop shape and a spherical shape, with its upper section coupled to the hemispherical top through a neck section.

21. The massage pad structure of claim 14, wherein the hemispherical top has a magnetic member embedded therein.

22. The massage pad structure of claim 14, wherein the hemispherical top is made of a ceramic material.

23. The massage pad structure of claim 14, wherein the hemispherical top is coated with a far infrared converting material.

24. The massage pad structure of claim 14, further comprising a dirt isolating layer covering the plurality of massage protrusions.

25. The massage pad structure of claim 14, wherein the pad plate includes an attachment layer disposed oh a lower surface.

26. The massage pad structure of claim 14, wherein the hemispherical top of the massage protrusion includes a groove.

27. The massage pad structure of claim 14, wherein the hemispherical top of the massage protrusion includes an opening on a top surface.

28. A method comprising the steps of:
providing a massage pad structure comprising a top surface with at least one opening for accessing a chamber in the massage pad structure; and,
inserting a massage protrusion into the chamber through the opening, the massage protrusion having a top portion being movably disposed on the top surface and further having a bottom portion being retained in the chamber.
